(19) United States
(12) Patent Application Publication
(10) Pub. No.: US 2013/0055565 A1
(43) Pub. Date: Mar. 7, 2013

(54) MANUFACTURE OF CORED WELDING ELECTRODES

(71) Applicants: Marie A. Quintana, Twinsburg, OH (US); Janet Morse, Painesville, OH (US); Jonathan Sterling Ogborn, Concord, OH (US); Greg Gerth, Kirtland, OH (US); Vaidyanath B. Rajan, Mentor, OH (US); Radhika R. Panday, Mayfield Village, OH (US)

(72) Inventors: Marie A. Quintana, Twinsburg, OH (US); Janet Morse, Painesville, OH (US); Jonathan Sterling Ogborn, Concord, OH (US); Greg Gerth, Kirtland, OH (US); Vaidyanath B. Rajan, Mentor, OH (US); Radhika R. Panday, Mayfield Village, OH (US)

(73) Assignee: LINCOLN GLOBAL, INC., City of Industry, CA (US)

(21) Appl. No.: 13/668,961

(22) Filed: Nov. 5, 2012

Related U.S. Application Data
(62) Division of application No. 12/861,009, filed on Aug. 23, 2010.
(60) Provisional application No. 61/257,660, filed on Nov. 3, 2009.

(51) Int. Cl. B23K 35/40

(52) U.S. Cl. 29/825

(57) ABSTRACT

The outer metal sheath of a cored welding electrode is made by twin roll casting without cold rolling.

### RELATED APPLICATIONS

This application claims the benefit of pending U.S. provisional patent application Ser. No. 61/257,660 filed on Nov. 3, 2009, for MANUFACTURE OF CORED WELDING ELECTRODES, the entire disclosure of which is fully incorporated herein by reference.

### BACKGROUND

Commonly-assigned US 2006/0255027 as well as the many patents cited therein describe how cored welding electrodes are typically made. The entire disclosure of US 2006/0255027 is incorporated herein by reference. As described there, a flat metal strip forming the outer sheath of the electrode is continuously fed through a series of work stations which form the strip into a U or V shape, deposit a desired fill material in the base of the U or V, and then bend the open arms of the U or V together to fully enclose the deposited fill material. Normally, the cored electrode structure so formed is drawn through one or more suitable dies for compacting the electrode and setting its final diameter.

In commercial practice, the metal strip forming the outer metal sheath of such an electrode is normally obtained by sectioning an “endless” metal sheet which has been obtained from its manufacturer in the form of a standard mill roll, i.e., a roll 3 to 6 feet (˜0.9-˜1.8 m) in width and thousands of feet in length. These standard mill rolls, in turn, are made by casting the molten metal into an ingot or “slab,” hot and cold rolling (wrought processing) the slab so formed into a sheet having the desired final thickness, e.g., ˜0.040 inch (˜1 mm), and then winding the sheet so formed up upon itself.

Two different casting processes are normally used. In conventional slab casting, the molten metal is continuously cast into an ingot on the order of ˜8-12 inches (˜200-305 mm) thick, which is then hot and cold rolled to the final desired thickness. In thin slab casting, the molten metal is continuously cast into an ingot on the order of 1-3 inches (˜25-76 mm) thick, which is then hot and cold rolled to the same final desired thickness. In both cases, substantial reductions in thickness are involved requiring multiple hot and cold rolling steps. Moreover, in both cases, the final thickness of the product sheet is achieved by cold rolling with subsequent solution anneal and Kemper roll. This is necessary because hot rolling will not achieve a final thickness which is sufficiently uniform across the entire width of the “endless” metal sheet to be commercially useful.

In this regard, it is very important in the manufacture of cored welding electrodes that the relative proportion between the core and the sheath remain constant along the entire length of the electrode as well as from electrode to electrode in order to insure uniform performance of different electrodes as well as different portions of the same electrode. This, in turn, requires that the “endless” metal sheet from which the outer sheath of the electrode is derived exhibit a uniform thickness across its entire surface area in order that different metal strips cut from this sheet have exactly the same mass. Unfortunately, “endless” metal sheets made from welding grade steel in which the final thickness of the sheet has been set by hot rolling exhibit a certain non-unifoiniity in thickness especially from side to side. The practical result is that such sheets cannot be used for making cored welding electrodes because too many portions are outside of thickness tolerances.

This problem does not occur when the final thickness of the “endless” metal sheet is set by cold rolling with subsequent solution anneal. Thus, the outer sheaths of cored welding electrodes intended for welding iron and steel are almost always made from “endless” metal sheets whose final thickness in manufacture has been set by cold rolling followed by solution anneal.

### SUMMARY

In accordance with this invention, it has been found that metal sheets made from welding grade steels whose final thickness has been set by hot rolling will exhibit the necessary uniformity in thickness for use in making cored welding electrodes, provided that the casting from which these metal sheets are derived is made by twin roll casting In particular, it has been found that metal sheets which are made by twin roll casting from welding grade steels will exhibit the necessary uniformity in thickness from region to region and especially from side to side even if the final thickness of sheets is set by hot rolling only, i.e., even if the metal sheets are made without cold rolling.

Thus, this invention provides a continuous process for making a cored welding electrode comprising an outer metal sheath in the form of a hollow tube and a core of a fill material inside the hollow tube, the cored welding electrode being made by a procedure in which the lateral edges a metal strip foiiiiing the metal sheath are bent to form the strip into a U or V shape, a fill material is deposited in the base of the U or V, and the lateral edges of the U or V are then bent together to enclose the fill material and form the cored electrode, wherein the metal strip is made by twin roll casting without cold rolling.

In addition, this invention also provides a cored welding electrode comprising an outer metal sheath in the form of a hollow tube and a core of a fill material inside the hollow tube, wherein the outer metal sheath is made by twin roll casting without cold rolling.

### DETAILED DESCRIPTION

### Twin Roll Casting

Twin roll casting is a continuous casting procedure in which the molten metal to be cast is fed into the nip between a pair of closely-spaced counter-rotating rolls whose axes are arranged horizontal and parallel to one another. It is described in a number of patents beginning with U.S. Pat. No. 49,053 to Bessemer and including U.S. Pat. No. 4,784,209, U.S. Pat. No. 5,031,688, U.S. Pat. No. 6,776,218, U.S. 2006/0244317, U.S. 2006/0289142, U.S. 2007/0169914, U.S. 2008/0219879 and U.S. 2008/0264599, the entire disclosures of which are incorporated herein by reference.

A significant feature of twin roll casting is that it is a “near net shape” casting procedure. “Near net shape” is a term used in the metal casting industry to connote a casting procedure which produces an ingot or casting that is relatively similar in size and shape to the size and shape of the final product desired in the sense that relatively little shaping of the ingot or casting is required to achieve the final product.

So, for example, twin roll casting can be used to make cast strip having intermediate thicknesses of ≦5 mm, ≦4 mm, ≦3 mm, ≦2 mm and even ≦1 mm. In this context, “intermediate thickness” refers to the thickness of the cast strip produced by twin roll casting as opposed to the thickness of the final metal sheet product obtained from this cast strip, which is referred to in this disclosure as the “final thickness” or “final desired thickness.” Because the intermediate thicknesses of this cast strip is so small, relatively little working (wrought processing) is need to achieve the final thickness desired, e.g., ˜0.040 inch (˜1 mm). For example, to achieve a 1 mm final thickness from a cast strip having a thickness of 3 mm, the amount of thickness reduction required is only a factor of 3. In contrast, thin slab casting requires a thickness reduction by a factor of ˜25 (from an ingot thickness of ˜25 mm to a final sheet thickness of ˜1 mm), while conventional slab casting requires a thickness reduction by a factor of ˜250 (from an ingot thickness of ˜250 mm to final sheet thickness of 1 mm), to achieve the same desired final thickness. In accordance with this invention, it has been found that, because the amount of thickness reduction needed to achieve final desired thickness is so small when the cast strip is made by twin roll casting, distortions in product sheet thickness caused by hot rolling are insignificant and/or non-existent. Thus, the necessary uniformity in product sheet thickness can be achieved even though hot rolling is used to set final sheet thickness, i.e., even though the metal sheet is made without cold rolling.

The outer sheath of the inventive cored welding electrode can have any conventional thickness. Normally, the product metal strip from which this outer metal sheath is made will have a final thickness ranging anywhere between ˜0.3 to ˜3 mm, although final thicknesses on the order of ˜0.5 to ˜2 mm, ˜0.7 to ˜1.5 mm, or even ˜0.8 to ˜1.2 mm, are more common. Similarly, the intermediate thickness of the cast strip produced by twin roll casting which is hot rolled to the final desired thickness in accordance with this invention can also be of any conventional thickness. For example, this cast strip can be made by twin rolling casting twin in intermediate thicknesses from as small as ˜0.5 mm to as large as ˜20 mm and more, although intermediate thicknesses on the order of ≦15 mm, ≦10 mm , ≦8 mm, ≦6 mm, ≦5 mm, ≦4 mm, ≦3 mm, ≦2 mm and even ≦1 mm, are more common. For example, intermediate thicknesses on the order of 0.5 mm to 3 mm, 0.6 mm to 2 mm and even 0.7 mm to 1.8 mm are common.

However, it is desirable that the ratio between the intermediate thickness of the cast strip and final desired thickness of the product metal strip made from this cast strip be ≦4, and desirably ≦3 or even ≦2, since this minimizes the amount of thickness reduction required to achieve the final thickness of the product metal strip and hence minimizes the adverse effect of hot rolling on thickness uniformity.

### Metallurgy of the Sheath

As indicated above, this invention differs from conventional approaches for making cored welding electrodes in that, in this invention, the outer metal sheath of the inventive cored welding electrode is made by (or derived from a metal sheet made by) twin roll casting without cold rolling, as described above. One effect of this difference is that the metallurgy of the steel forming this outer sheath is different from an otherwise identical steel made by conventional continuous casting procedures in which the final thickness of the product sheet is set by cold rolling.

As well appreciated in metallurgy, cold rolling affects the grain structure of an alloy by breaking apart its larger grains into smaller grains. This effect is realized in this invention as well in that the grain size of the alloys forming the outer metal sheaths of the inventive cored welding electrodes is typically on the order of ˜50 to ˜150 μm, because these outer metal sheaths have been made by hot rolling only. This grain size is considerably larger than found in metal sheaths made by conventional continuous casting techniques, which is typically on the order of ˜10 to ˜20 μm. Accordingly, even though the chemistry and physical structure of a particular cored welding electrode made in accordance with this invention may be identical to that of a conventional cored welding electrode, these two electrodes are nonetheless different from one another because the grain structure of the steel in the outer sheath of the inventive cored welding electrode is different from the grain structure of the steel in the outer sheath of the conventional electrode.

In terms of chemistry, the outer sheath of a conventional cored welding electrode intended for iron and steel welding is normally made from a conventional welding grade steel, which typically contains about 0.02-0.05 wt. % C, about 0.25-0.35 wt. % Mn and ≦0.02 wt. % Si. One or more optional ingredients such as Ni, Mo, Cr, Nb, V, Ti and B can also be included, normally in a total amount of 2 wt % or less. Such steels are normally “aluminum-killed,” meaning that a small amount of aluminum has been included as a deoxidizer to insure that the oxygen content of the steel is reduced as much as practical. As a result, the steel ultimately obtained also normally contains a small yet still significant amount of aluminum, typically on the order of about 0.03 to 0.07 wt. %. Other chemistries are possible such as, for example, using “titanium-killed” or “silicon-killed” steels. Where Si-killed steels are used, the steel will normally contain on the order of 0.03 to 0.07 wt. % Si and ≦0.02 wt. % Al, in addition to the other ingredients indicated above. Meanwhile, “titanium-killed” steels are generally too expensive for use in most welding applications and, in addition, are not generally available in the United States, at least at the “commodity prices” necessary for widespread use.

The outer metal sheath of the inventive cored welding electrode can be made from any steel which is otherwise useful for making the outer metal sheath of conventional cored welding electrode and, in addition, which can be continuously cast by means of twin roll casting. For example, these outer metal sheaths can be made from the conventional welding grade steels described above. In addition to these steels, low carbon steels, i.e., steels having a carbon content of ˜0.05-˜0.15 wt. %, can be used as can mild steels, i.e., steels having a carbon content of ˜0.16-˜0.29%.

In accordance with another feature of this invention, steels which have been enriched in Mn for the purpose of improving their performance in twin roll casting can be used to special advantage in making the outer metal sheaths of the inventive cored welding electrodes In this regard, the above-mentioned U.S. 2006/0243417 in paragraphs [0043]-[0047] indicates that manganese and to a lesser extent silicon, when added to a typical low carbon steel, reduce the frequency of “chatter defects” when the steel is twin roll cast. In addition, the above-mentioned U.S. 2008/0219879 indicates that Mn plus small amounts of Nb substantially increase the age hardening response of thin steel strip made by twin roll casting, provided that the steel contains <0.25 wt. % C. These Mn enriched steels can be used to special advantage in this invention, since they are normally made with a significantly reduced aluminum content which, in turn, enables the welds made from these steels also to be made with a significantly reduced aluminum content.

In this regard, aluminum although an excellent deoxidizer is also known to reduce fracture toughness, at least in welds made from metal cored welding electrodes, due to the formation of aluminum oxide inclusions in the crystal structure of the weld metal formed. This fracture toughness problem can be reduced at least somewhat by replacing some of the aluminum with other deoxidizers such as Mn, Si and Mg. However, these other deoxidizers are too expensive for most welding grade steel applications, at least when such steels are made by conventional continuous casting techniques. The Mn-enriched steels described above, because they are made by twin roll casting, are less expensive to manufacture not only because the degree of thickness reduction required is much less but also because cold rolling has been totally eliminated. As a result, these steels can be made and delivered at reasonable, cost competitive prices even though they contain significant amounts of Mn, Si and other ingredients.

The Mn-enriched steels described above generally contain <0.25 wt. % carbon, ˜0.2 to ˜2.0 wt. % Mn and ≦0.02 wt. % Al. Even more desirable steels contain ≦0.015 wt. % Al, or even ≦0.01 wt. % Al. They can also contain various additional ingredients such as ˜0.05 to ˜1.0 wt. % Si, ˜0.01-˜0.20 wt. % Nb and similar amounts of other ingredients commonly incorporated into such steels, examples of which include V, Ti, Ta, Mg, etc. Such steels containing ≦0.20 wt. % ≦0.15 wt. %, ≦0.10 wt. %, ≦0.07 wt. % and even ≦0.05 wt. %, carbon are especially interesting, as are steels containing ˜0.55 wt. % to ˜0.90 wt. % Mn, especially those also containing ˜0.1 to ˜0.35 wt. % Si.

### Fill Material

Cored welding electrodes come in two basic varieties, flux cored welding electrodes in which the core is made from a welding flux, and metal cored welding electrodes in which the core is made predominantly from additional metals to be incorporated in the weld to be formed. This invention is applicable to making cored welding electrodes using any fill material which has previously been used, or which may be used in the future, for making either variety of these cored welding electrodes. That is to say, the inventive cored welding electrodes can be made with any type of core material, whether a flux core or a metal core.

Such core materials are well known and described, for example, in the following patents: U.S. Pat. No. 6,787,736, U.S. Pat. No. 6,855,913, U.S. Pat. No. 6,939,413, U.S. Pat. No. 7,091,448, U.S. Pat. No. 7,147,725, U.S. Pat No. 7,300,528, as well as many, many more.

As indicated above, these core material are normally formulated to be used with outer sheaths formed from conventional welding grade steel which, as further indicated above, are aluminum-killed steels typically containing about 0.02-0.05 wt. % C, about 0.25-0.35 wt. % Mn, ≦0.02 wt. % Si, about 0.03-0.07 wt. % Al, with the balance being Fe and other incidental impurities. For convenience, the formulation of such a core material, i.e., a core material formulated to be used with sheaths made from conventional welding grade steel, will be referred to in this disclosure as a “standard core formulation.”

Many core materials, both flux type and metal type, include significant amounts of Mn. In accordance with another aspect of this invention, modified core materials are specially formulated for use with outer sheaths made from the above-noted Mn enriched steels by reducing their Mn concentrations accordingly. As well appreciated in the art, the chemistries of the sheath and core of a particular cored welding electrode are selected so that the electrode, as a whole, delivers a desired combination of ingredients to the weld site. When an Mn enriched steel is selected for use in making the outer core of an inventive cored welding electrode, the increased concentration of Mn in the sheath may provide a higher than desired concentration of Mn in product electrode if a core material with a standard core formulation is used. Therefore, in accordance with this aspect of the invention, modified core materials are formulated with reduced concentrations of Mn (and Si in some instances as well) so that the overall chemistry of the product electrode remains unchanged.

So, for example, if an Mn-enriched steel contains 0.75 wt. % Mn instead of the 0.30 wt. % level found in a typical welding grade steel, the amount of Mn included in the modified fill material made in accordance with this aspect of the invention is reduced by a corresponding amount so that the total amount of Mn delivered to the weld site remains unchanged. That is to say, where it is desired to replace a conventional cored welding electrode (whose sheath is made from a conventional welding grade steel and whose core material has a standard core formulation) with an inventive cored welding electrode whose sheath is made with an Mn enriched steel, the modified fill material used for this purpose is formulated to have a reduced concentration of Mn so that the total amount of Mn delivered to the weld site remains the same as that provided by the conventional electrode. This allows cored welding electrodes made with the above Mn enriched sheaths to match the chemistry of conventional cored welding electrodes exactly. In addition, it also reduces overall costs, since the amount of Mn needed to complete the core is reduced.

This same advantage of reducing the need for an element in the core because an increased concentration of that element is found in the sheath may also apply to Si and such other elements that may be found in the above Mn-enriched steels in higher than normal concentrations, i.e., in concentrations which are higher than found in the conventional welding grade steels normally used for forming the outer sheath of a cored welding electrode.

### Making the Electrode

The inventive cored welding electrode is made in the same way as conventional cored welding electrodes except that the metal strip used to form the outer sheath of the electrode is made from a steel which has been produced by twin roll casting without cold rolling.

Thus, the inventive cored welding electrode is made by feeding a metal strip produced by twin roll casting without cold rolling through a series of work stations which bend the lateral edges of the strip to form the strip into a U or V shape, deposit a desired fill material in the base of the U or V, and then further bend the lateral edges of the U or V together to fully enclose the deposited fill material, thereby forming the cored electrode. Normally, this cored electrode structure is then drawn through one or more suitable dies for compacting the electrode structure and setting its final diameter, although this is not absolutely necessary. If desired, a suitable drawing lubricant can be applied to the outer surface of the metal strip to aid the drawing process.

### EXAMPLE

In order to more thoroughly describe this invention, the following working examples is provided:

### Example 1

A metal sheet for use in making the outer sheath of a cored welding electrode of this invention was made by a twin roll casting procedure as generally described in U.S. 2006/0243417. For this purpose, a molten steel heat comprising ˜0.04 wt. % C, ˜0.3 wt. % Mn, ˜0.02 wt. % Si and ˜0.04 wt. % Al, with the balance being Fe and incidental impurities was continuously cast through a twin roll caster operated to produce cast strip ˜1.6 mm thick and 450 mm wide at a casting speed of 80 m/min. The cast strip so obtained was then immediately hot rolled by a series of 2-5 hot rollers to a finished thickness of 0.040 inch (˜1 mm), the finished sheet so formed having an overall width of 18 inches (46 cm). The finished sheet was continuously wound up upon itself to form a coil approximately 20-25 metric tons.

The coil was transported to a slitting station in where it was continuously fed through an industrial slitter which slit the sheet into 32 longitudinal strips, each being approximately 14 mm wide. The thickness of each strip was measure by a micrometer and found to be within +0.05 mm of the desired thickness of 0.040 inch (˜1 mm).

The individual strips so made were then used to form a cored welding electrode by the general procedure described in U.S. 2006/0255027. For this purpose, each strip was fed through an electrode forming assembly as generally shown in U.S. 2006/0255027 at a speed of 80 m/min. A flux core material comprising 35 wt. % metallic powders, 63 wt. % oxides and 2 wt. % fluorides was deposited on the strip at a rate such that 15 gms flux material was contained in each 100 grams of completed electrode. After deposition of the core material, the lateral edges of the strip were brought together and closed to faun an electrode structure, which was then run through a conventional compaction die to set the final diameter of the electrode product.

Although only a few embodiments of this invention have been described above, it should be appreciated that many modifications can be made without departing from the spirit and scope of the invention. All such modifications are intended to be included within the scope of this invention, which is to be limited only by the following claims:

1. A continuous process for making a cored welding electrode comprising an outer metal sheath in the form of a hollow tube and a core of a fill material inside the hollow tube, the cored welding electrode being made by a procedure in which the lateral edges a metal strip forming the metal sheath are bent to form the strip into a U or V shape, a fill material is deposited in the base of the U or V, and the lateral edges of the U or V are then bent together to enclose the fill material and form the cored welding electrode,
wherein the metal strip is made by twin roll casting without cold rolling.

2. The process of claim 1, wherein the final thickness of the metal strip is set by hot rolling.

3. The process of claim 2, wherein the metal strip is a section of a metal sheet which is made by twin roll casting without cold rolling.

4. The process of claim 3, wherein the metal strip is made by a twin roll casting procedure which produces a cast strip having an intermediate thickness followed by hot rolling the cast strip to produce the metal strip having a final thickness, and further wherein the ratio between the intermediate thickness and the final thickness is ≦4.

5. The process of claim 4, wherein the ratio is ≦2.

6. The process of claim 4, wherein the metal strip is made from a steel containing <0.29 wt. % carbon

7. The process of claim 6, wherein the metal strip is made from an Mn-enriched steel containing <0.25 wt. % carbon and ˜0.2 to ˜2.0 wt. % Mn.

8. The process of claim 7, wherein the Mn-enriched steel contains ≦0.02 wt. % Al.

9. The process of claim 8, wherein the Mn-enriched steel contains ˜0.05 to ˜1.0 wt. % Si.

10. The process of claim 7, wherein the Mn-enriched steel contains ˜0.55 wt. % to ˜0.90 wt. % Mn and ˜0.1 to ˜0.35 wt. % Si.

11. The process of claim 1, wherein the cored welding electrode is a metal cored welding electrode.

12. The process of claim 1, wherein the cored welding electrode is a flux cored welding electrode.

13-24. (canceled)

25. In a continuous process for making a modified cored welding electrode in which the lateral edges a metal strip forming the metal sheath are bent to form the strip into a U or V shape, a fill material is deposited in the base of the U or V, and the lateral edges of the U or V are then bent together to enclose the fill material and form the cored welding electrode,
a method for making the modified cored welding electrode so as to have an overall chemistry that is identical to the chemistry of a conventional cored welding electrode, the conventional cored welding electrode having a core made from a core material having a standard core formulation and a sheath made from a welding grade steel having a standard sheath formulation,
the method comprising:
(1) selecting as the metal strip used to form the modified cored welding electrode a metal strip made by twin roll casting a steel having an increased concentration of Mn and Si relative to the standard sheath formulation, the steel containing <0.25 wt. % carbon and ˜0.2 to ˜2.0 wt. % Mn, the metal strip being made without cold rolling, and
(2) selecting as the core material to be used in making the modified cored welding electrode a modified core material having a composition with a reduced concentration of Mn and Si relative to the standard core formulation, the concentration of Mn and Si in the modified core material being reduced sufficiently so that the total amount of Mn and Si delivered to a weld site by the modified cored welding electrode is the same as that delivered by the conventional cored welding electrode.
